(19) United States
(12) Patent Application Publication
(10) Pub. No.: US 2016/0236393 A1
(43) Pub. Date: Aug. 18, 2016

(54) Coated Preform for Container and Method for Producing Same

(71) Applicant: LIN.K N.V.

(72) Inventors: Dirk De Cuyper, Destelbergen (BE); William Dierickx, Destelbergen (BE)

(21) Appl. No.: 15/021,856

(22) PCT Filed: Sep. 15, 2014
(86) PCT No.: PCT/BE2014/000046

§ 371 Date: Mar. 14, 2016

(30) Foreign Application Priority Data
Sep. 13, 2013 (BE) 2013/0605

(51) Int. Cl. B29C 49/00; B65D 25/14

(52) U.S. Cl. CPC B29C 49/0005; B65D 25/14; B29K 2031/04

(57) ABSTRACT

This invention relates to a coated preform of a biaxially stretchable plastic material, for use in the manufacture of a container and a coated. At least one coating layer (3, . . . ) comprised of polymeric coating is on the outside of the plastic preform (10) is applied. Which is remarkable in that said coating is formed with at least a base layer (3) which is made of polymers that have similar structures, esp polar. It also relates to the corresponding method for this purpose.

### FIELD OF THE INVENTION

The present invention relates to a coated preform, resp. container provided with a coating, as well as a method for the manufacture thereof.

### BACKGROUND OF THE INVENTION

Coating of materials is a known technique for improving the characteristics of a supporting material or substrate, such as plastics containers or their preforms. Thus PET, as a material often used in the packaging sector, has a number of drawbacks which can be resolved by means of a coating:

This is the case for the barrier characteristics exhibited by certain plastics containers or preforms, wherein for some products the gas and moisture barrier characteristics of PET are not adequate to achieve a sufficiently long shelf life. This is evident in the packaging of oxidation-sensitive drinks, such as fruit juice or wine, which demand a higher oxygen barrier. For carbonated drinks, the shelf life is dependent on the CO₂ content, whereby a high CO₂ barrier is necessary in order to reduce the gradual loss of CO₂. Also the moisture barrier of PET is insufficient for drinks requiring a long shelf life. As a result of the loss of moisture during the storage time, a partial vacuum is formed in the bottle, whereby the latter collapses and thus exhibits a crushed appearance, which is not visually attractive;

Another characteristic consists in the chemical resistance, since PET has insufficient chemical resistance against alkaline products, inter alia, and cationic and non-ionic surfactants. Alkaline products cause a degradation of PET through hydrolysis, whilst stress cracking occurs under the influence of non-ionic and cationic surfactants. Both processes degrade the physical characteristics of PET, whereby tears and leaks can arise;

A still further characteristic in this context is that of crash resistance. During various production stages of PET bottles, scratches can occur on the surface of preforms or bottles, which can lend an undesirable visual effect hereto.

The application of a coating can remedy all these problems. The coating of both PET preforms and bottles is also, however, known per se: the application of a coating to a PET preform or bottle etc. in order to improve the gas barrier characteristics has already been described in various patent publications, for example.

### PRIOR ART

Document US 2003/0194563 thus describes a coating applied to plastics packagings, such as bottles, but also foils, in order to improve the gas barrier characteristics. The coating consists of an organic component having barrier characteristics, such as PVOH, and an epoxide component which, following curing, offers increased moisture protection. Epoxy has a glass-like structure, so that it is impossible to stretch this from preform to bottle. Indeed, it is not a stretchable material, which is regarded as a disadvantage here, so that it is the aim to remedy this below.

In WO 2009/070800 of Advanced Plastic Technologies, a method of improving the barrier characteristics of PET bottles by means of a UV curing coating is disclosed. To this end, PET preforms are treated with a coating which consists of an unsaturated ethylene-based monomer and an initiator for cross-linking. After this, the preform is blown before the coating has hardened, and is afterwards irradiated with UV light in order to cure the coating. This is difficult to manage because preforms are not transportable in this state, since they would begin to stick. Added to this is the fact that an extra energy step comprising UV curing is necessary here. However this after-treatment step can be relinquished in the development proposed below.

In DE10153210 & EP 2532600 of Kurary Europe, the use of a multilayer coating of polyvinyl acetal, polyvinyl alcohol and polyvinyl butyral to increase the gas barrier of PET bottles is disclosed. This coating is applied to the preform or bottles and consists of different layers of moisture-sensitive PVA/PVOH with a PVB top layer in order to be sufficiently moisture-resistant. It does not however disclose a method, which in this technology is a common flaw.

### OBJECT OF THE INVENTION

According to the present invention the starting premise here is that the most suitable method of providing plastics bottles, in particular of PET, with a coating consists in coating the preform already prior to the blowing process. With regard to containers, it is stated that they are generally intended to hold a product in such a way that its distinguishing features and characteristics are retained as much as possible and remain as stable as possible over time. A purpose of the present invention consists in providing a container of the abovementioned type. The barrier layer is hereby optimized in its blocking action, wherein the migration of particles in both directions, i.e. both from inside to out and from outside to in, is barred.

By virtue of the coating, the aforementioned problem of stress cracking can be avoided, wherein this is compensated by virtue of the proposed coating. The coating of preforms is favoured over the coating of bottles, as preforms are smaller and have a more regular shape than bottles. From one type of preform, even very divergent designs of bottles can be blown. This makes it easier to coat preforms, rather than bottles or ordinary containers. It thus seems more productive to devise a suitable method of applying coatings, which method can be used for one single type of preform instead of different bottle shapes, whereof the number of shaping possibilities is virtually unlimited, and consequently more difficult to manage on a large-scale basis in mass production compared to a preform, more standard.

The application of a coating to a preform does however pose a number of difficulties, which have hitherto made the use thereof much more difficult. For, following the application of the coating, a curing phase is necessary. This curing phase entails a certain drying time, possibly at an elevated temperature, a reaction time or an irradiation with energy, such as UV light. During this curing phase, no contact must take place between different preforms, since this can lead to sticking, or even damaging, of the coatings. Consequently, the coating needs to be applied to individual preforms.

A following problem resides in the blowing of, for example, PET preforms, or more generally from a biaxially stretchable material. During the blowing, preforms are heated to above the glass temperature of PET and are subsequently biaxially stretched mechanically. During this process, the coating can start to tear, delaminate or spread itself unevenly. In order to avoid this, it is important that the coatings have a glass temperature which is that of PET—or, where appropriate, of another used biaxially stretchable material. Thus the composition of the coating is crucial to allowing good stretching and adhesion to the substrate of stretchable material, in particular biaxially.

### SUMMARY OF THE INVENTION

To this end, a coated preform is proposed according to the invention as defined in the main claim. it is generally stated that this is appropriate for stretchable materials, in particular biaxially, such as plastic, polyethylene, polypropylene, etc. Coatings applied to the outside of the container should be sufficiently scratch-resistant to prevent damaging of the coating.

According to a preferred embodiment of the invention, a coating consisting of various polymers, especially those which possess a similar structure, more particularly consisting of a branched vinyl acrylate, is applied. The point here is that if a polymer branches, then it has a good adhesion and sticks. Glues are actually resins which are very strongly branched, but since the molecule is very small, a very compact stacking of all the small molecules is obtained, so that they block that.

According to a further preferred embodiment of the invention, a coating consisting of the aforementioned branched vinyl acrylate is used, wherein short chains are branched in the middle. This lends adhesion to PET and the short chains ensure very compact stacking in cured coating, resulting in better blocking. As far as this compatibility of the polar groups is concerned, it was able to be established that the aforementioned vinyl acrylate is preferable, because it, in terms of structure, can offer a virtually perfect stacking. The most notable aspect was that it was able to be established that it has such a good affinity with PET. The adhesion to PET is thus extremely good. This affinity with PET can be attributed to the fact that it has good compatibility and belongs to a polar group. As far as the drying time is concerned, this is short, but that is usually to do with the quantity of water which is present in the coating.

The ingenuity is ultimately that if one were to lay open PET, one would have periodically a polar group. With the molecule which is produced there if the distance between the polar groups is equal, an ideal situation is attained. With this preferred material, it is presumed that these polar groups go together very well.

Nevertheless, according to a remarkable embodiment of the invention, PET is used, in view of its widespread use notably in preforms for 2-step containers, to be coated on the outside to avoid contact of the coating with foods.

According to yet another embodiment thereof, the base layer is VAC.

A water-borne VAC coating is selected as the best possible coating for PET. In process terms, VAC has a rapid drying time, a very good adhesion to PET, and it exhibits good stretching in the blowing of a preform.

Functionally, a VAC coating exhibits a good chemical barrier for PET. Furthermore, it also has, as a base layer, a good adhesion layer for other functional barrier coatings which do not themselves exhibit good adhesion with PET.

According to an additional embodiment of the invention, the coating consists of polyvinyl butyral (PVB), which ensures a very good moisture barrier. This is also a very small molecule and we are thus faced with branches, but also with a polar group which adheres to the surface of the PET, because one there has polar groups. These two last-named components, namely both vinyl acrylate copolymer and PVB, have a dense packing of materials and thereby result in good blocking.

Possibly there is also styrene acrylate, which forms a base coating characterized by good adhesion to PET, as a sort of primer. Now acrylates are in any event able to adhere to PET, thus that does not have to be branched, but they also give a very compact stacking. The compact stacking does not have the same origin in the three cases.

The aforementioned polarity of embodiment above helps to achieve adhesion. On the one hand, good adhesion to the PET is necessary, whilst, on the other hand, the stacking must be good and the adhesion is caused there by these polar groups. Without doubt, the acrylates are a polar group which goes well together with the PET group.

Subordinately, the coating can also consist of alkyd systems. A large number of materials have been tried out, including a number which work in a less satisfactory manner.

Analogously with coatings consisting of two component systems in the meaning of 2 separate components. For it was able to be experimentally established that an effect could be observed, subject to a suitable and well-chosen combination of 2 different materials, which was not however present for each component separately.

Thus, inter alia, the 2-component coatings consisting of polyurethane with isocyanate; acrylate compounds with isocyanate; polyol with isocyanate; epoxy component with alkyd; styrene acrylates with a glycol ether solvent, with, in particular, propylene glycol dimethyl ether, propylene glycol methyl ether, propylene glycol butyl ether, et al.

These polymer coatings have as the most important functionality a good adhesion with PET, a relatively short drying time, sufficient flexibility, a glass temperature lower than or equal to that of PET in order to allow stretching during the blowing, good chemical resistance, and good waterproofness.

To these polymer coatings can possibly be added additives, such as surfactants, softeners, anti-foaming agents, bactericide products, etc., in order to improve specific characteristics.

According to a second main embodiment of the invention, the coating consists of barrier additives, wherein these can be a pure component or a water-borne coating or can be added as additive to the polymer-borne coating.

According to a first sub-embodiment thereof, the barrier additives are an organic component; according to a specific embodiment thereof, the aforementioned organic component consists of EVOH, where appropriate also PVOH, as the barrier material.

This can possibly also consist of polyolefins such as malein-modified PP/PE in order to increase the moisture barrier; or, where appropriate, of EVA/PVA in order to improve the gas and/or chemical barrier; or else of metasilicate or metasilicate.5H2O, in order to improve the gas barrier and/or chemical resistance, likewise moisture-proofness.

According to a second sub-embodiment thereof, the barrier additives can also be a bio-based component, characterized by excellent gas barrier characteristics; according to a privileged embodiment thereof, it consists of micro-organisms such as, in particular, spores or yeasts, where appropriate so-called polymer bio-aggregates, and the like.

According to a further embodiment thereof, it consists of lipids, especially archaeal lipids.

According to an even further embodiment thereof, it consists of polysaccharides, such as in particular pectins, pullulan, chitosan, gelatine, cellulose, starch.

According to a yet further embodiment thereof, it consists of proteins, especially whey proteins.

According to a still further embodiment thereof, it consists of enzymes, especially oxidoreductases, decarboxylases, lactoperoxidases, lysozymes, hydrolase, etc.

These bio-based additives have as the most important functionality the enhancement of the moisture/O₂ and/or CO₂ barrier characteristics.

The coating can consist of a single-layer or multilayer coating. In the case of a multilayer coating, this can consist of two or three layers. In this case possibly a polymer-based coating is applied as the base layer owing to good adhesion with a view to preventing delamination problems, in aforementioned barrier applications, including a biocoating. An organic barrier-additive-based coating is also applied thereto. To this is possibly applied, as a third layer, a polymer-based top coating, owing to the moisture-proofness. A significant advantage in this is thus a structure of better quality by virtue of the fact that significantly less delamination occurs between the layers. After all, such materials have the drawback that they give rise to delamination when converted into a container.

According to a somewhat less used yet still useful embodiment thereof, the coatings are applied to the inside of the preform in order to avoid the hydrolysis of the PET material by the loaded product.

The present invention also relates to a device or system for implementing the aforementioned method for applying a coating to the container, or preform as defined in the corresponding claims. According to a preferred embodiment of the device of the invention, in particular for bottle-type containers, a coating is applied to the preform by means of a spraying system, wherein a coating is sprayed onto the surface of a preform. This can be realized both with so-called air systems and airless systems. This system has the advantage that a homogeneous and thin-layer coating can be applied in a rapid manner.

According to a further embodiment of the system of the invention, an electrostatic coating is carried out, wherein the coating is electrically charged in the spray head and wherein the product to be coated is earthed to the mass. As a consequence, in the course of the spraying, the coating drops are attracted to the product, namely for the coating of the preforms. For the coating of preforms, this can preferably be carried out on a take-up trolley.

According to the development of a remarkable electrostatic coating technique according to the invention, the preform is placed over a metal pin which is earthed to the mass. At the moment that an electrostatically charged coating is sprayed, the charged drops are directed through the electrical field towards the pin and thus end up on the preform. More specifically, the preforms are placed on a take-up core during the after-cooling process. These take-up cores are mounted on a grab, which is connected via the machine to the earthing. At that moment, the preforms can thus be coated via an electrostatic process without introducing an extra manipulation step into the production process for this purpose.

According to an additional embodiment of the system of the invention, a preform is dipped in a coating bath. This method has the advantage that it is relatively simple, but the layer thickness of the coating is difficult to control, with the result that this is less suitable in certain applications.

The coating can preferably be applied just after injection moulding, for example during transport on the trolley, or possibly just before blowing, before or after the heating of the preforms.

Just after the injection moulding, the preforms still have a surface temperature of approximately 60° C., whereby the drying of the coating is accelerated. In the coating carried out just before the blowing, the coating is dried during the heating of the preforms or applied to a warm preform.

Further particularities and features of the invention are defined in the further sub-claims; further details are explained in more detail in the description following hereinafter in some embodiments of the invention with reference to the attached drawings.

### BRIEF DESCRIPTION OF THE DRAWINGS

FIG. 1 is a mixed side view of an embodiment of the preform according to the invention with a partial cross section through the wall thereof;

FIG. 2 is a detailed representation of a traditional simple preform wall having one layer;

FIG. 3 is an enlarged view of the detailed representation from the preform wall according to FIG. 1, more specifically of a preform section according to the invention having a simple coating on the outside of the preform wall;

FIGS. 4 and 5 are analogous representations as in the previous figures, though of a preform section according to the invention with a double or triple coating on the outside of the preform wall;

FIG. 6 is a further analogous representation, though of a preform section according to the invention, having a simple coating on both sides of the preform wall;

FIG. 7 represents an asymmetric section of a further embodiment of the preform wall according to the invention, according to an analogous principle as represented in FIG. 3, with in this case a triple layer on the outside and a simple coating on the inside;

FIG. 8 represents a side view of a container according to the invention, likewise with an enlarged detailed representation according to an analogous principle as in FIG. 1 and for which the enlarged detailed representations are represented in FIGS. 2 to 7;

FIG. 9 is a schematic representation of a method step according to the invention, with the use of dipping carried out by means of a device according to the invention provided for this purpose;

FIGS. 10 and 11 respectively represent a schematic representation of a privileged method according to the invention, by means of a device provided for this purpose;

FIGS. 12 and 13 show a combined use of overmoulding and coating on a preform, or the wall section thereof;

FIG. 14 is a schematic functional representation of a grab as is commonly found in a robotized device for producing injection-moulding preforms.

### DESCRIPTION

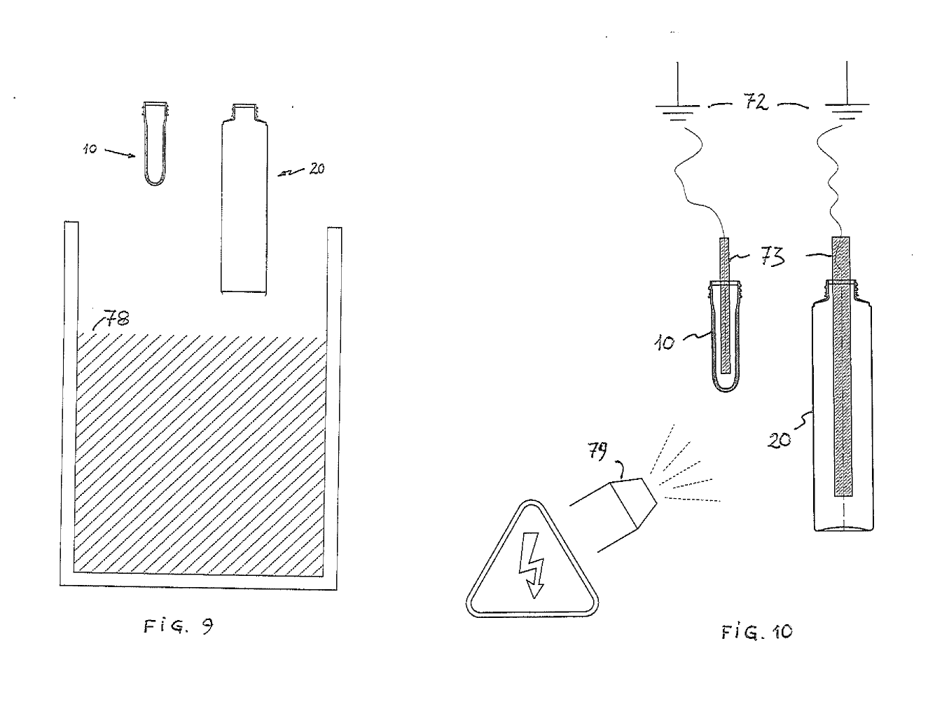

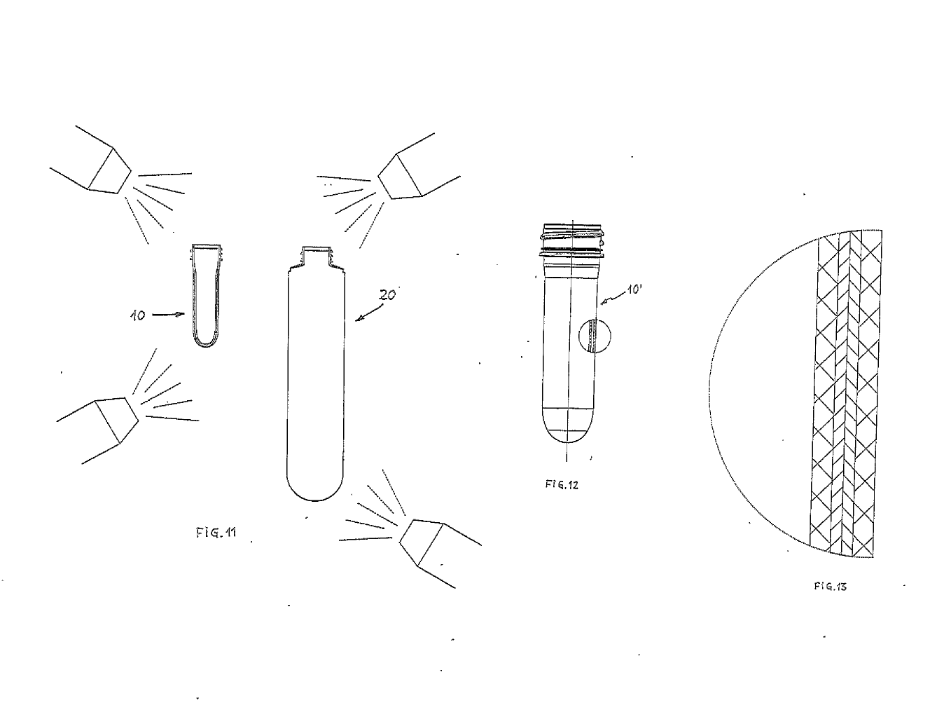

Generally the container is produced from a preform 10 made of substantially biaxially stretchable plastics material using the so-called barrier technique. The container is represented in its finished form 20 in FIG. 8, and in its semi-finished form in the guise of a preform 10 as the semi-finished product as shown in FIG. 1 with a longitudinal axis l with its neck portion 1, a hereto adjoining wall portion 2; 22, and a bottom portion 7; 27 thereof. This 7 possesses a gate 47, along which the plastics material is injected into an injection moulding die (not represented) provided for this purpose. The preform is of the monolayer type, as represented in the figure, wherein this is then composed of a primary material with the formation of a primary layer, wherein the said primary material is formed by a plastics material; this can also be of the multilayer type, having a multilayer structure comprising, where appropriate, a barrier layer in the actual wall 22 of the preform already prior to coating. This multilayer structure is a privileged use—albeit not shown—of a preform as a semi-finished product for the blow-moulding of a container. It essentially relates to containers in which drinks, foods, cosmetics and other products, both liquid and solid, can be packed and stored, such as bottles, jars, beakers, tins, cans and jerry cans.

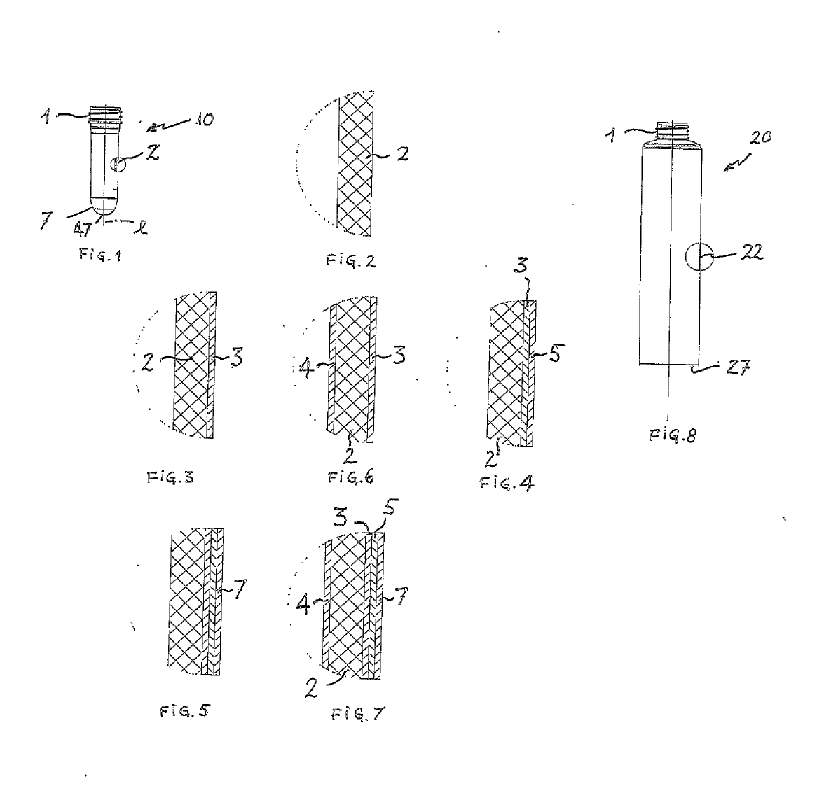

FIG. 2 is a detailed representation of a wall fragment section of a traditional container or preform which is not treated with a coating layer. By contrast, FIG. 3 et seq. show illustrative embodiments of preforms 10, or, more specifically, a section thereof, which are all treated according to the invention by the application of a coating layer, beginning with a base layer coating 3, of which the number, however, can vary according to the needs and applications. The most elementary embodiment here is represented by FIG. 3 with one single coating layer, which constitutes the base coating. This is hence also the most common.

For PET bottles, for example, which are provided with a barrier coating, the preform 10 is thus already coated prior to the blowing process. After all, the coating of preforms is chosen above the coating of bottles 20, since preforms are smaller and have a more regular shape than bottles. Consequently, preforms are more easily transportable at a considerably lower cost than the actual containers, and on the one hand, whilst the shape of the containers is defined in the blowing thereof, on the other hand, wherein the preforms 10 are blown to form the final containers 20. This extreme diversity in shape in the finished containers 20 as the end product makes an after-treatment by coating hereof naturally much more laborious and complex than an analogous after-treatment in respect of preforms as the semi-finished product. After all, the latter have a standard shape, which is thus more suitable for an appropriate coating treatment in mass production.

Following the application of the coating to the perform, there is a curing phase. This consists of a drying time, possibly at an elevated temperature, a reaction time, or radiation with energy, for example UV light.

In the case of PET preforms 10, these are heated to above the glass temperature of PET and are subsequently biaxially stretched mechanically. As coatings, those are chosen which have a glass temperature≦those of PET, in order to avoid a situation in which, during the blowing of the performs, the coating starts to tear, delaminate or spread itself unevenly.

The coating 3 is applied to individual preforms 10. The composition of the coating is designed to allow good stretching and adhesion to PET. Thus,

FIG. 3 shows a preform section which is coated 3 on the outside thereof 10 in order to avoid subsequent contact of the coating with foods which are to be received in the derived blown container 20. Coating materials occasionally possess an aggressive composition. This is attributable to the very concentrated functionality thereof, which in specific cases is given hereto or sometimes even imposed hereon. Thus, for example, a whole range of divergent barrier functions, precisely in order to protect the foods to be received against undesirable external influences. Consequently, it is vitally important to in these cases avoid all contact between the coating layers to be applied on the one hand, and the foods which are due to be received in the container on the other hand. Hence the coating layers are generally applied to the outside of the preform wall 20, and only in specific cases to the inside thereof. Thus, for example, the coatings 3, 5 or 7 are applied to the outside of a bottle 20, which coatings must be sufficiently scratch-resistant to prevent damaging of the base coating 3.

Exceptions are the coatings 4 applied in order to increase the chemical resistance of the PET to the filled product. These 4 should always be applied to the inside, as shown in FIG. 6.

As far as its composition is concerned, the coating consists, for example, of various polymers, wherein a favoured material herein consists in branched vinyl acrylate, in particular whereof short chains are branched in the middle. With a good adhesion to PET and the short chains, a compact stacking in cured coating with better blocking is ensured. These thus form the best material choice, for they have the best effect, in particular as regards adhesion and chemical resistance.

A particular notable advantage of VAC consists in the fact that this perfectly accompanies the aforementioned primary material polymer in the blowing operation, which in the present invention is generally formed by a biaxially stretchable material such as PET. It is precisely here that the technical ingenuity is encapsulated, namely in the VAC base layer by virtue of the joint stretching thereof, together with the primary material which forms the wall 22 of the actual preform 10. By virtue of this excellent characteristic, a superb compliance is realized between the VAC coating 3 on the one hand, and the primary wall layer 22 of the preform 10 on the other hand, during the blowing operation. The distinguishing characteristic of biaxial stretching of the primary material of the preform is fully utilized to give rise to a container 20 produced herefrom as the finished product, more specifically a coated container. This is attributable to the very good adhesiveness of the VAC coating 3 to the biaxially stretchable wall material under known blowing conditions.

In short, VAC is consequently best qualified as the base layer for the coating 3, since this material undergoes the blowing transformation well, on the one hand, and, by virtue of its particular structure, possesses a good adhesion characteristic, on the other hand. Under the same deformation conditions, many materials would start to break during the blowing operation, which, however, is not the case with VAC.

Another candidate is polyvinyl butyral (PVB), which, after all, ensures a good moisture barrier; and, more specifically, styrene acrylate can possibly also be used as the base coating 3 or 4 owing to good adhesion to a preform wall made of PET. Where appropriate, also alkyd systems.

In addition, there are also dual-component systems such as polyurethane with isocyanate, polyol with isocyanate, epoxy component with alkyd, acrylate compounds with isocyanate, styrene acrylates with a glycolic acid solvent, for example propylene glycol dimethyl ether, propylene glycol methyl ether, propylene glycol butyl ether, et al. These polymer coatings have, as the most important functionality, a good adhesion to PET as the material of the preform wall, a relatively short drying time, sufficient flexibility, a glass temperature that of PET in order to allow stretching during the blowing, a good chemical resistance, and a good waterproofness.

To these polymer coatings 3, 5, 7 can possibly be added additives, such as surfactants, softeners, anti-foaming agents, bactericide products, et al, in order to improve specific characteristics.

Barrier additives can be a pure component or a water-borne coating, or can be added as an additive to the polymer-borne coatings.

Barrier additives can either be an organic component, such as, in particular, EVOH, or PVOH as the barrier material, or possibly also polyolefins, such as malein-modified PP/PE in order to increase the moisture barrier; or, yet again, EVA/PVA.

In an extremely advantageous manner, these can also however be formed by a bio-based component such as, principally micro-organisms, especially spores, yeast, et al; PBA's; or lipids, for example archaeal lipids; or also polysaccharides, for example pectins, pullulan, chitosan, gelatine, cellulose, starch; or else proteins, namely whey protein; or finally enzymes, especially oxidoreductases, decarboxylases, lactoperoxidases, lysozymes, hydrolase, etc. These bio-based additives have, as the most important functionality, the enhancement of the moisture/O2 and/or CO2 barrier characteristics.

The coating may consist of a multilayer coating 3 or 5, 7 and/or 4, 6, 8. FIG. 4 shows the case of a multilayer coating 3, 5 consisting of two external layers placed one on top of the other. A polymer-based coating is here applied in an advantageous manner as the base layer 3, preferably of VAC, to which there is applied a bio-based barrier coating 5, to which possibly, as a third layer 7, a polymer-based top coating is applied.

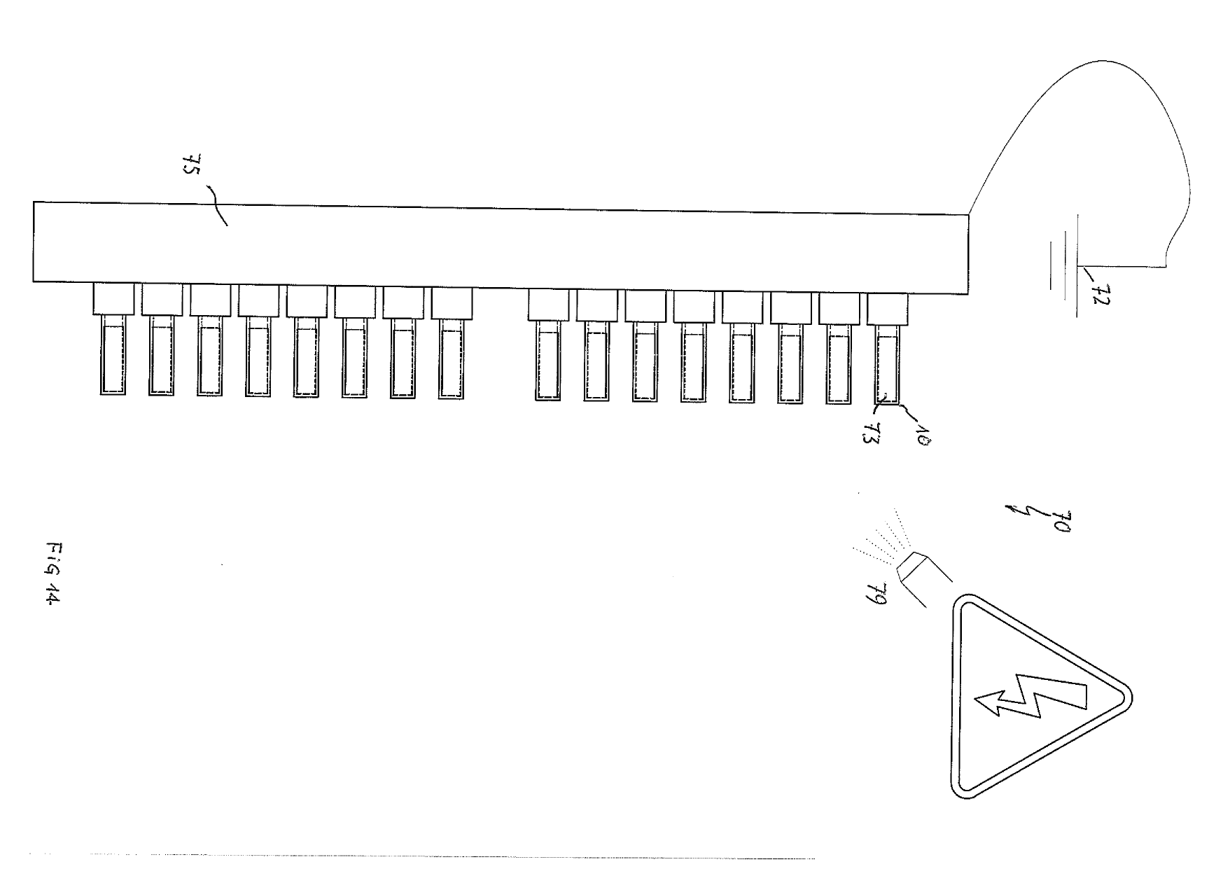

As far as the application method is concerned, the coating is preferably applied to the preform 10 by means of a spraying system, wherein a coating is sprayed onto the surface of a preform, as shown in FIG. 11. This can be realized both with air systems and airless systems. This method has the advantage that a homogeneous and thin layer of coating can be applied in a rapid manner.

FIG. 9 shows the dipping process: here a preform 10 is dipped in a coating. This method has the advantage that it is relatively simple, but the layer thickness of the coating is difficult to control.

FIG. 10 shows electrostatic coating, a technique in which the coating is electrically charged in the spray head and the coating drops are attracted to the product. For the coating of preforms, this can preferably be carried out on a trolley.

The coating can preferably be applied just after injection moulding, for example during transport on the truck, or possibly just before blowing, before or after the heating of the preforms.

Just after the injection moulding, the preforms still have a surface temperature of approximately 60° C., whereby the drying of the coating is accelerated.

In the coating just before the blowing, the coating is dried during the heating of the preforms or applied to a warm preform.

The last FIG. 14 is schematic representation of a grab such as those which are found in a robotized device for the production of injection moulding preforms, such as, for example in WO2014/082140, to which reference is made.

### EXPERIMENTAL EXAMPLES

1. VAC was applied to an 85×195 mm piece of PET with a 50 μm coater and dried overnight at room temperature. An adhesion test was conducted after 1, 2, 7 and 14 days. In all cases, the adhesion was 100%

### Example 2

1% silanil was added to VAC, in order to improve the flexibility. Subsequently, the coating was applied as in Example 1 and an adhesion test was likewise conducted after 1, 2, 7 and 14 days. In all cases, the adhesion was 100%.

### Example 3

Two bottles were coated on the inside, by means of dipping, with 70% VAC coating diluted with water. Coated bottles were dried overnight at room temperature. One bottle was placed under pressure of 3.5 bar. On both bottles an adhesion test was conducted after 7 days, and in both cases this was 100%.

### Example 4

A 10% PVOH solution in water was applied as coating to PET, as described in Example 1. After 1 and 2 days, an adhesion test was conducted, wherein 0% adhesion was always detected.

### Example 5

A piece of PET as described in Example 1 was provided with a multilayer VAC/PVOH/VAC coating. For this purpose, a first layer of VAC coating was applied and dried overnight, a second layer of PVOH coating was applied and dried overnight, and a third layer of VAC coating was applied and dried overnight. An adhesion test was conducted on the coating after 1, 2, 7 and 14 days, wherein 100% adhesion was always detected.

### Example 6

A PET bottle was coated, by means of dipping, with a 70% hydrous solution of VAC coating and dried overnight at room temperature. The bottle was placed under pressure of 3.5 bar, and a non-ionic surfactant was applied to the shoulder. The very same non-ionic surfactant was applied to a non-coated bottle applied as reference. Stress cracking was monitored after 6 hours, 1, 2 and 7 days, and after 1 month of storage at room temperature. The non-coated bottle already displayed after 1 day significant stress cracking, whilst, in the case of the coated bottle, still no stress cracking could be observed after 1 month.

### Example 7

A PET bottle was coated as described in Example 6. The bottle was placed under pressure of 3.5 bar, and a non-ionic surfactant was applied to the shoulder. The very same non-ionic surfactant was applied to a non-coated bottle as reference. Stress cracking was monitored after 6 hours, 1, 2 and 7 days, and after 1 month of storage at 40° C. The non-coated bottle already displayed after 6 hours significant stress cracking, whilst, in the case of the coated bottle, still no stress cracking could be observed after 1 month.

### Example 8

A PET bottle was coated as described in Example 6. The coated bottle and a non-coated bottle were half-filled with a 29% solution of NaOH and stored at 40° C. The wall thickness of both bottles was monitored over time. The decrease in wall thickness of the coated bottle was less than half the decrease in wall thickness of the uncoated bottle.

### Example 9

A PET bottle was coated with a double-layer coating, wherein the first layer consisted of VAC and the second layer of PVdC. This gave a significant improvement in terms of adhesion of the PVdC coating, and the moisture barrier was improved by a factor of 2 compared with a same PVdC coating without VAC layer.

### Example 10

Of the very same bottle with double-layer coating as in Example 9, the oxygen barrier was measured. A doubling of the oxygen barrier in relation to a standard bottle could be measured.

### Example 11

A PET preform was realized with the same double-layer coating as in Example 9. From this preform a bottle was blown and the oxygen barrier thereof was measured. A doubling of the oxygen barrier in relation to a standard bottle could be measured.

### Example 12

A PET bottle was coated with a double-layer coating, wherein the first layer consisted of VAC and the second layer of EVOH. In an oxygen measurement, a doubling of the oxygen barrier in relation to a standard bottle could be measured.

### Example 13

A PET bottle was coated with a double-layer coating, wherein the first layer consisted of VAC and the second layer of PVOH. In an oxygen measurement, a doubling of the oxygen barrier in relation to a standard bottle could be measured.

### Example 14

A PET bottle was coated with a double-layer coating, wherein the first layer consisted of VAC and the second layer of pectin. In an oxygen measurement, a 4-fold improvement of the oxygen barrier in relation to a standard bottle was able to be measured.

Starting from test 9, for which the gas barrier coating was improved in relation to the standard, three more additional types of coating were further developed which yielded good results as revealed by the above tests, wherein the three examples 9, 10 and 11 together deliver the following: it was able to experimentally establish that the first layer is advantageously formed by a coating layer 3 of VAC, which thus makes itself the obvious choice as the base coating layer 3. A chemical barrier is yet achieved herewith for the coated preform 10 of the invention.

Should a gas and/or moisture barrier be desired as well, depending on the desired application, extra coating layers can best be applied of the type 5, 7, which are applied on top of the aforementioned base layer 3, namely:
a PVDC coating of the above type; and/or
an EVOH coating layer or PVOA, and finally also
a biomaterial layer, in particular with pectin as tested above.

Moreover, additional coating layers 5, 7 can also be applied to the base layer 3 for a wide range of compositions thereof, by virtue of the broad compatibility of VAC, from which the coating base layer 3 is compiled, with the other coatings 5, 7.
Thus the tests revealed that good results could be obtained with three groups and four applications on the basis of the following combination:
a) VAC is chosen as the base layer for the coating 3 with its good chemical barrier characteristics;
b) also applied hereto is an additional layer of PVDC, also with its distinguishing characteristics;
c) EVOH or PVOH analogously, and finally
d) biomaterial, in particular pectin.

1. Preform made of a biaxially stretchable plastics material intended for the production of a plastics container provided with a coating, wherein the latter has at least one coating layer (3) consisting of a polymer coating on at least a portion thereof, characterized in that said at least one coating layer (3) is provided on the outside of the preform (10).

2. Preform according to claim 1, characterized in that said coating (3) is made from polymers which have similar structures, from vinyl acrylate copolymer (VAC).

3. Preform according to claim 1 or 2, characterized in that said coating consists of polymers which have similar polar structures particularly from branched vinyl ester.

4. Preform according to one of the preceding claim 2 or 3, characterized in that said coating consists of a branched vinyl ester, having short chains branching in the middle thereof.

5. Preform according to any one of the preceding claims, characterized in that at least one additional coating layer (5, 7) is provided on the coating base layer (3), particularly on its exterior, which is scratch-resistant in order to prevent damage to the base coating (3).

6. Preform according to the preceding claim, characterized in that said additional coating layer (5) and/or (7) is composed of PVdC generating an increased adhesion of the coating, as well as of the moisture barrier compared to the same PVdC coating without VAC layer.

7. Preform according to claim 5, characterized in that said at least one additional coating layer (5, 7) is composed of EVOH providing a pronounced increase of the oxygen barrier compared to a standard bottle, particularly ranging up to a doubling thereof.

8. Preform according to claim 5, characterized in that said at least one additional coating layer (5, 7) is composed of PVOH generating a pronounced increase of the oxygen barrier compared to a standard bottle, particularly ranging up to a doubling thereof.

9. Preform according to claim 5, characterized in that said at least one additional coating layer (5, 7) is composed of an organic component, generating a marked increase of the oxygen barrier compared to a standard bottle, particularly ranging up to more than a doubling thereof, up to a quadruple improvement of the oxygen barrier.

10. Preform according to claim 5, characterized in that said at least one additional coating layer (5, 7) is composed of a bio-component and in particular pectin.

11. Preform according to one of the claims 3 to 10 when dependent on claim 1, characterized in that a coating consists of polyvinyl butyral (PVB) which generates a good moisture barrier.

12. Preform according to one of the preceding claims, characterized in that it provided with a barrier coating, possibly with a barrier in its own wall (22).

13. Preform according to one of the preceding claims, characterized in that said coating (3, 5, 7; 4) contains barrier additives, particularly which are a pure component or a water-based coating or being incorporated into the polymer-borne coatings as an additive.

14. Preform according to the preceding claim, characterized in that said barrier additives have an organic component, having as functionality an increase of the moisture/O2 and/or CO2 barrier properties.

15. Preform according to the preceding claim, characterized in that the aforementioned organic component consists of EVOH or PVOH as a barrier material.

16. Preform according to claim 13, characterized in that the barrier additives have a bio-component which consists of micro-organisms such as in particular spores or yeasts, and the like.

17. Preform according to claim 13, characterized in that said bio-component consists of so-called polymer bio-aggregates (PBA), which are composed of a polymer and a set of organisms, which are selected from cells and/or cell products, wherein the aggregates are formed by said cells and/or cell products that are processed in said polymer thus forming the polymer-bio aggregate, whereby a new function of said formed polymer product is thus generated.

18. Preform according to claim 13, characterized in that the abovementioned bio-component is composed of lipids, especially archaeal lipids.

19. Preform according to claim 13, characterized in that the organic bio-component consists of polysaccharides, particularly pectins, pullulan, chitosan, gelatin, cellulose, and/or starch.

20. Preform according to claim 13, characterized in that the above-mentioned bio-component is composed of proteins, in particular whey protein.

21. Preform according to claim 13, characterized in that the abovementioned bio-component is made up of enzymes, in particular oxidoreductases, decarboxylases, lactoperoxidases, lysozymes, hydrolase, and the like.

22. Preform according to one of the preceding claims, characterized in that said at least one coating layer is provided on the inside of the preform.

23. Preform according to one of the preceding claims, characterized in that the above-mentioned stretchable material is formed by PET, wherein the coating has a glass transition temperature value which is smaller than or equal to the one of PET.

24. Method for coating a preform made of a biaxialy stretchable plastics material, as defined in any one of the preceding claims, characterized in that the preform (10) is first coated from the outside and is then blown with formation of a container (20) according to a blow-molding process, wherein, during the blowing, the preform is heated to above the glass transition temperature of the abovementioned stretchable material, and subsequently biaxially stretched mechanically, notably wherein the coating has a glass transition temperature value which is smaller than or equal to the glass transition temperature value of the stretchable material.

25. Method according to claim 24, characterized in that PET is selected as stretchable material, wherein the coating has a glass transition temperature which is smaller than or equal to the one of PET.

26. Method according to the preceding claim, characterized in that for the VAC base layer, a water-borne VAC coating is selected as coating (3) for the primary PET layer of the preform wall (22), where in the process VAC has a fast drying time, a good adhesion to PET and wherein it stretches well when blowing of a preform, further wherein a VAC coating functionally exhibits a good chemical barrier for PET, and wherein it is also a good adhesion layer as a base layer (3) for other functional barrier coatings (5, 7) for the case that the latter do not have good adhesion to the PET wall layer (22).

27. Method according to any one of claims 24 to 26, characterized in that after applying the coating a curing phase is carried out, particularly wherein said curing phase consists of a drying step, possibly at an elevated temperature, a reaction step, or an irradiation with a certain energy, in particular UV light, wherein each preform (10) remains isolated during said curing phase wherein the coating is carried out on individual preforms.

28. Method according to any one of the claims 24 to 26, particularly for containers (20) of the bottle type, characterized in that the coating is applied to the preform (10) by means of a spraying system, wherein a coating (3) is sprayed on the surface of a preform, possibly with air or airless systems, particularly for quickly applying a homogeneous and thin film coating.

29. Method according to any one of the claims 24 to 27, characterized in that the preform is coated electrostatically, wherein the coating is charged electrically in a spray head (79), and wherein the product (10) to be coated is earthed to the mass (72), wherein when spraying the coating droplets are attracted to the product (10).

30. Method according to the preceding claim, characterized in that the preform (10) is positioned over a metal pin (73) which is earthed to the mass (72), wherein at the time that an electrostatically charged coating is sprayed, the charged droplets are directed to the pin by the electric field and which finally end up on the preform to be coated.

31. Method according to the preceding claim, characterized in that the preforms are positioned during the post cooling process on a take-up core (74), wherein said cores are mounted on a gripper arm (75) which is connected to the ground (72) via the preform injection molding robot (70), wherein the preforms (10) are coated by an electrostatic process at that time, without additional manipulation therefor in the production process.

32. Method according to any one of claims 24 to 31, characterized in that the coating is applied just after injection molding, particularly during transportation on a trolley provided for this purpose, or possibly just before blowing, before or after heating of the preforms.

33. Method according to any one of claims 24 to 32, characterized in that the preform is dipped in a coating bath (78).

34. Method according to any one of the preceding claims, characterized in that the at least one coating layer (4) is applied on the inside of the preform (10), particularly for the sake of avoiding hydrolysis of the stretchable material by the filled product.

35. Method according to claim 32, characterized in that the plastic preform, resp. container is coated inside after its formation according to the aforementioned blow molding process.

36. Method according to any one of the claims 24 to 35 when depending on 17, characterized in that said cells and/or cell products are embedded in said polymer.

37. Method according to the preceding claim, characterized in that said cells are selected among the category of the so-called cysts and/or in the phase of the non-active or dormant stages; or resp. among the prokaryotes, in particular bacteria, and/or eukaryotes, particularly of the type protists, fungi, plants, and/or animals.

38. Method according to claim 36, characterized in that said cell products are selected within the category of so-called metabolites, i.e. the molecules which are synthesized biochemically by organisms.

39. Method according to claim 36, characterized in that the polymers are selected among the family of polyesters, in particular polyolefins, resp. polyethylenes, more particularly PET.

40. Method according to claim 36, characterized in that the polymers are selected among the family of polypropylenes.

41. Method according to any one of claims 36 to 40, characterized in that a PBA-layer is applied as an intermediate layer in a multi-layer packaging material for food products, in particular PET bottles for beverages, with at least one coating layer (3, 4) thereon.

42. Method according to any one of claims 36 to 41, characterized in that the polymer component of PBA is formed by PET, while the PBA bio-component is a yeast strain having a drying stage which is tolerant for the high temperatures of the manufacturing process.

43. Method according to the preceding claim, characterized in that instead of, and/or possibly in combination with the yeast cells in the PBA an algae species is incorporated, the duration stages of which block very intense UV light.

44. Method for coating a plastic container (20) of the bottle type made of a biaxially stretchable material, provided with a coating, characterized in that at least one coating layer consisting of a polymer coating is applied on at least a portion of the plastic bottle preform, and in that said at least one coating layer is applied on the outside of the preform, particularly to avoid contact between the coating and food products to be preserved in the container.

45. Packaging product of the container type manufactured from a preform as defined in any one of the claims 1 to 23, by means of a method as defined in any one of the claims 24 to 44, characterized in that it is coated with at least one barrier layer and, if need be, an outer layer.
